(19) United States
(12) Patent Application Publication
(10) Pub. No.: US 2006/0016931 A1
(43) Pub. Date: Jan. 26, 2006

(54) High-lift, low-drag dual fuselage aircraft

(76) Inventors: Frank S. Malvestuto, San Diego, CA (US); John Richard Hanscomb, Western Shore (CA)

Correspondence Address: MICHAEL BLAINE BROOKS, P.C., P.O. BOX 1630, SIMI VALLEY, CA, 93062-1630, US

(21) Appl. No.: 11/046,034

(22) Filed: Jan. 27, 2005

Related U.S. Application Data
(60) Provisional application No. 60/540,212, filed on Jan. 28, 2004.

(51) Int. Cl. B64C 39/12

(52) U.S. Cl. 244/45 R

(57) ABSTRACT

Disclosed is an aircraft including forward and aft wings, interposed between a port fuselage and a starboard fuselage, the port fuselage being substantially parallel to and coplanar with the starboard fuselage; a T-tail stabilizer system mounted aft and topside of the fuselages having a spanning horizontal stabilizer in some embodiments; propulsion systems mounted to each of the fuselages; and, in some embodiments, deflectable canards, tillable wings and wing-mounted propulsion systems.

### CROSS REFERENCE TO RELATED APPLICATIONS

This application claims the benefit of provisional application No. 60/540,212, to Frank Malvestuto, Jr., and John R. Hanscomb entitled “HIGH-LIFT, LOW-DRAG DUAL FUSELAGE AIRCRAFT,” filed Jan. 28, 2004, and is hereby incorporated by reference herein, in its entirety, for all purposes.

### FIELD OF THE INVENTION

The present invention relates to aerial vehicles and more specifically to aircraft having one or more horizontal airfoils having spans bounded in dual fuselage configurations.

### BACKGROUND

Aircraft, having multiple fuselages, and amphibious aircraft, having multiple hulls, have been proposed as high lift and low draft air vehicles achieved via one or more horizontal wings bounded on each of their tips by a fuselage. U.S. Pat. No. 3,844,432 to Blanchard, Jr. et al. discloses an aircraft having multiple fuselages addressing large nose-down pitching moments generated by the flap high-lift forces. Elevator control is achieved via horizontal tails extended outboard from each to the outmost fuselages. Rudder control is achieved via vertical tails extending upwards from each of the outmost fuselages.

U.S. Pat. No. 3,159,361 to Weiland discloses an amphibious aircraft having multiple fuselages or hulls having interposed between them a forward negatively swept horizontal wing and an aft negatively swept horizontal wing in tandem. The tandem negatively swept horizontal wings each have a pair of pivotally mounted turbo-props. Rudder control is achieved via vertical stabilizers extending upwards from each of the hulls. Elevator control is achieved via a horizontal stabilizer above the plane of the tandem wings and connected to upper ends of the vertical stabilizers.

U.S. Pat. No. 3,244,246 to Weiland discloses an amphibious aircraft having multiple fuselages or hulls having interposed between them a forward horizontal wing and an aft horizontal wing in tandem. The tandem horizontal wings exploit ground effects using a plenum volume created via extendable vanes between the underside of each of the horizontal wings and the ground or water surface. Rudder control is achieved via vertical stabilizers extending upwards from each of the hulls. Elevator control is achieved via a horizontal stabilizer above the plane of the tandem wings and connected to upper ends of the vertical stabilizers.

There remains a need for aircraft having two or more wings having substantially parallel fuselages at each of the wingtips where turboprops or other propulsion systems are mounted at the nose or tail of each of the fuselages or where turboprops or other propulsion systems, when mounted on a wing section, the wing section may be articulated to orient the thrust vector. Further, there remains a need for aircraft having two or more wings having substantially parallel fuselages at each of the wingtips where canards may be used for finer pitch control absent adverse acceleration and aileron-induced roll control.

### SUMMARY

The invention in its several embodiments is an aircraft having port and starboard fuselages and at least two wings or bounded airfoils interposed between the fuselages. The port fuselage of the exemplary aircraft has a substantially cylindrical body with a port centerline, a nose portion, a mid-body portion and a tail portion. A port vertical stabilizer mounted topside and proximate to the tail portion of the port fuselage may be used or a T-tail stabilizer system. Some embodiments have an outboard port canard, proximate to the nose portion of the port fuselage. The outboard port canard may be complemented by an inboard port canard. The outboard port canard may have deflectable panel. A port propulsion unit may be mounted, preferably along the port centerline, at either the nose or the tail of the port fuselage. The starboard fuselage of the exemplary aircraft is substantially parallel to and coplanar with the port fuselage, and the starboard fuselage is also a substantially cylindrical body having a starboard centerline, a nose portion, a mid-body portion and a tail portion. A starboard vertical stabilizer is mounted topside and proximate to the tail portion of the starboard fuselage or T-tail stabilizer may be used. Some embodiments have an outboard starboard canard, proximate to the nose portion of the starboard fuselage. The outboard starboard canard may be complemented by an inboard starboard canard. The outboard starboard canard may have deflectable panel. A starboard propulsion unit may be mounted, preferably along the starboard centerline, at either the nose or the tail of the starboard fuselage. The propulsion unit may be a turbo-prop or a turbojet/turbofan, for example. Preferably a pusher turbo-prop propulsion system is mounted at the tail portion of the fuselages. The exemplary aircraft has a forward wing that may be described as having a leading edge and a trailing edge. The forward wing, as a substantially aerodynamic planar member, spans a region between the mid-body portion of the port fuselage and the mid-body portion of the starboard fuselage. Accordingly, the fuselages may be described as at the wingtips of the forward wing. The exemplary aircraft also has an aft wing that may be described as having a leading edge and a trailing edge. The aft wing, as a substantially aerodynamic planar member, spans a region between the mid-body portion of the port fuselage and the mid-body portion of the starboard fuselage so that it is substantially parallel to and above the plane of the forward wing and preferably aligned so that the leading edge of the aft wing is aft of the trailing edge of the forward wing. When each fuselage does not have its own respective T-tail stabilizer system, then a horizontal stabilizer spans from an upper section of the port vertical stabilizer to an upper section of the starboard vertical stabilizer.

Other embodiments of the invention include an aircraft having additional propulsion units, preferably a forward wing propulsion unit mounted at substantially the mid-span region of the forward wing and proximate to the leading edge of the forward wing and an aft wing propulsion unit mounted at substantially mid-span of the forward wing and proximate to the leading edge of the aft wing. In some embodiments the forward wing, the aft wing, or both wings are adapted to pivot substantially about the leading edge of each respective wing wherein the trailing edge of the respective wing preferably subtends an angle of less than twenty-one degrees.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1. is a top perspective view of an aircraft configuration, in accordance with an embodiment of the present invention;

FIG. 2 is a top view of an aircraft configuration, in accordance with an embodiment of the present invention;

FIG. 3A is a side view of an aircraft configuration, in accordance with an embodiment of the present invention;

FIG. 3B is a side view of an aircraft configuration having tilting wings, in accordance with an embodiment of the present invention;

FIG. 4A is a front view of an aircraft configuration having a partial T-tail stabilizer system, in accordance with an embodiment of the present invention;

FIG. 4B is a front view of an aircraft configuration having a full T-tail stabilizer system, in accordance with an embodiment of the present invention;

FIG. 5A is a top view of an aircraft configuration having alternate cockpit locations and propeller locations, in accordance with an embodiment of the present invention);

FIG. 5B is a top view of a canard-nosecone assembly of a fuselage of an aircraft configuration, in accordance with an embodiment of the present invention; and

FIG. 5C is a side view of an aircraft configuration having a canard system, in accordance with an embodiment of the present invention.

### DETAILED DESCRIPTION

The synergistic arrangement of wings between and bounded by fuselages that may also serve as cargo components of an aircraft provides for optimum aerodynamic and mission performance including amphibious take off and landing operations. The configurations of the invention improve the operations of current aircraft having conventional wing-fuselage configurations. Such operational improvements may include: an increased in range due to higher lift-to-drag ratios; an increase in payload due to an increase in lift and a reduction in structural weight; an improvement in airport and carrier operations due to significant reductions in wing span; a reduction in take-off speeds and distances due to higher wing lift at low speeds; and a significant reduction in production costs due to manufacturing preferably through composite construction. Preferably, the aircraft configuration of the present invention includes two or more wings located between two aerodynamic cargo bays or fuselages and a tail stabilizer assembly.

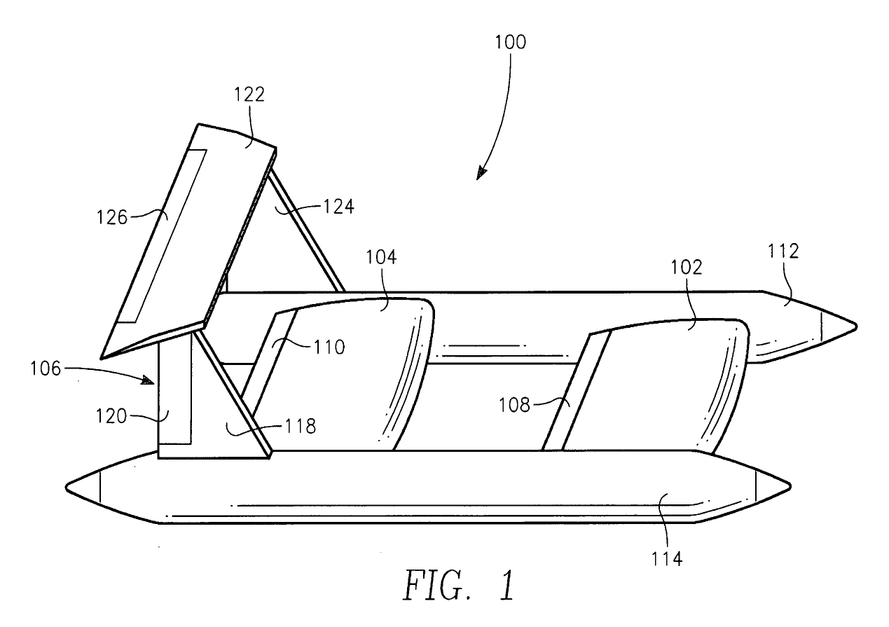

FIG. 1. illustrates an embodiment of an aircraft configuration 100 including a forward wing 102, an aft wing 104, and a T-tail stabilizer system 106. The forward wing 102 and an aft wing 104 in the preferred embodiment are interposed between two cargo bays or fuselages, namely a port fuselage 112 and a starboard fuselage 114. Preferably, the aircraft configuration illustrated in FIG. 1 has an entire span that is considerably less than conventional single wing-body aircraft configurations having otherwise similar flight characteristics. The forward wing 102 and aft wing 104, which are generally of equal length or span, have at least one forward wing flap 108 and at least one aft wing flap 110, respectively. In some embodiments of the invention, the aircraft configuration includes three or more wings. In other embodiments, the wings may each have one or more leading edge flaps.

The T-tail stabilizer system 106 of the embodiment illustrated in FIG. 1 includes a port vertical stabilizer/tail 124 having a port rudder (not shown), a starboard stabilizer/tail 118 having a starboard rudder 120 and a horizontal stabilizer 122 having at least one elevator 126.

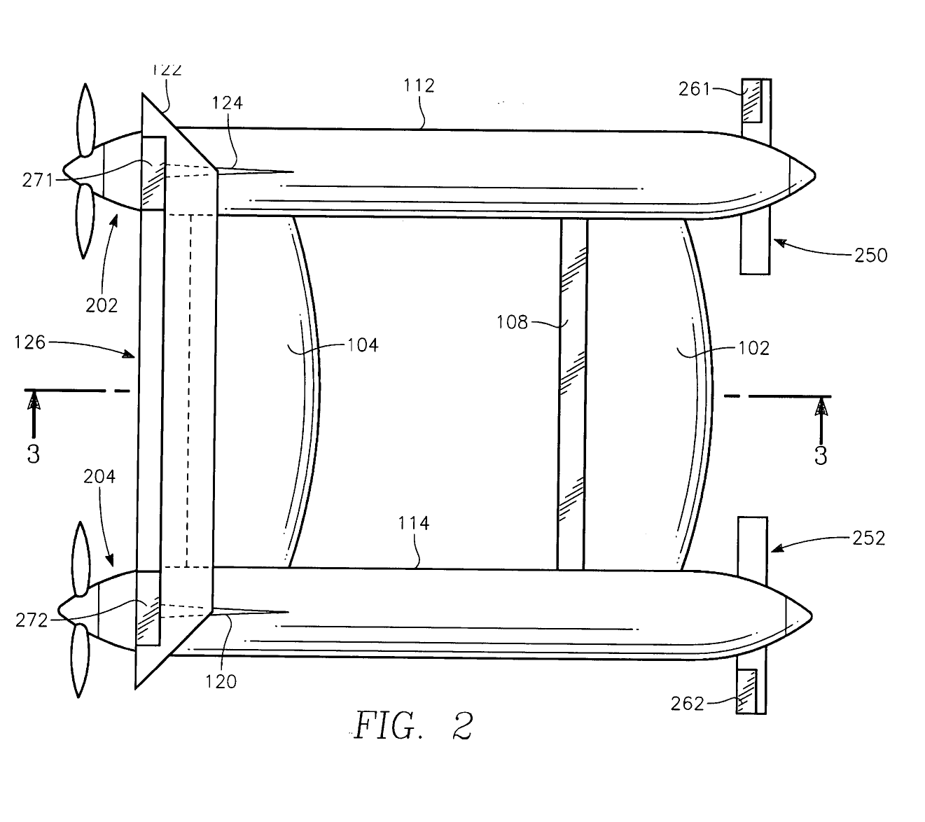

FIG. 2 is a top, planform, view of an embodiment of the present aircraft invention where exemplary propulsion and where roll control surfaces are shown. Illustrated in FIG. 2 is a port propulsion system 202, shown as a propeller pusher system, located at the rear of the port fuselage 112, and a starboard propulsion system 204, shown also as a propeller pusher system, located at the rear of the starboard fuselage 114. The propulsion systems 202, 204 and associated control systems may be any of a number of subsonic propulsion systems known to those of ordinary skill in the art including piston engines and jet engines, for example. The embodiment illustrated in FIG. 2 also has a port canard assembly 250 and a starboard canard assembly 252. Also shown in FIG. 2 are surfaces that may be deflected as ailerons. Some embodiments may have an outboard port canard aileron panel 261 and an outboard starboard canard aileron panel 262, some embodiments may have a port aileron panel 271 and starboard aileron panel 272 as part of the horizontal stabilizer 122, and others may use all four panels.

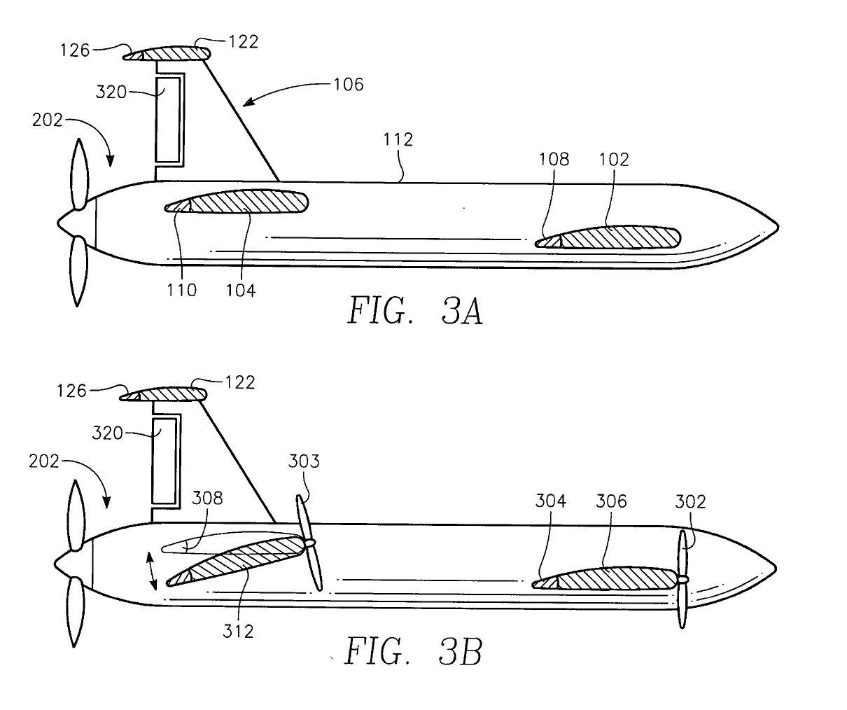

FIG. 3A is a transverse view of an aircraft configuration of FIG. 2. as indicated by 3. FIG. 3A further illustrates the respective locations of the forward wing 102, the aft wing 104, and the T-tail stabilizer system 106 in an embodiment of the present invention. In this view the port rudder 320 can be seen. While the inboard port canard surface is not illustrated in this figure, the port propulsion system 202 is illustrated as a propeller pusher system.

FIG. 3B illustrates another embodiment of the present invention where one or more of the wings, in this example the aft wing 104 and forward wing 102, are tilting wings capable of being rotated approximately 20 degrees in the preferred embodiment about an axis in a horizontal plane perpendicular to the longitudinal axis of each of the fuselages of the aircraft configuration. Each of the wings, as a pivoting and motorized tilting forward wing 306, having a flap 304 that may be retractable, and as a pivoting and motorized tilting aft wing 312 having a flap 308 that may be retractable, may further include a propulsion system, shown by example as a forward wing propeller 302 and an aft wing propeller 303 each preferably mounted at the leading edge of each wing. The propulsion systems may be turbo-prop systems or turbojet/turbofan systems preferably mounted substantially bisected the span of each wing. Being mounted mid-span may include attached to the wing within a nacelle or otherwise preferably aerodynamically attached with the engine portion shielded by a cowling.

Referring again to FIG. 3B, the forward tilting wing 306 is illustrated in a substantially horizontal orientation with respect to the direction of flight, while the aft tilting wing 308 is illustrated in an initial horizontal position moving into angled position with steeper angle of attach as shown with a direction arrow. Later in flight, the angle may be restored to level. These tilting wings 306 and 308 allow for maximal exploitation of the airfoil of the wing and provide re-directable thrust.

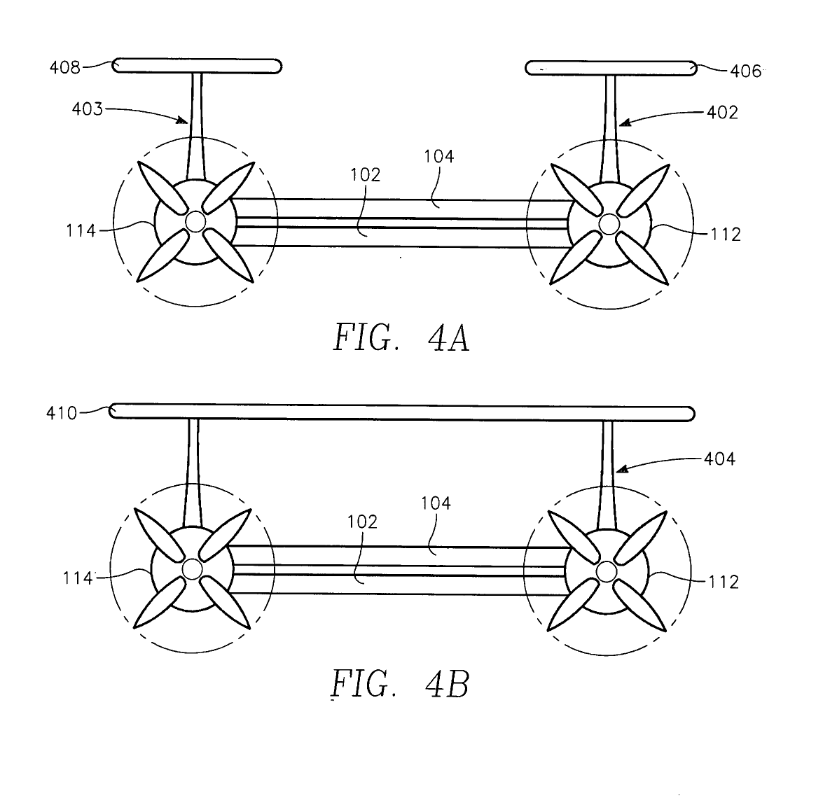

FIG. 4A is a frontal view of an exemplary aircraft configuration illustrating a port T-tail stabilizer system 402 and a starboard T-tail stabilizer system 403 in one embodiment of the present invention. As shown, each of the two fuselages 112, 114 includes a T-tail stabilizer system 402, 403 projecting vertically from the upper surface of the fuselage. Centrally disposed at the top of each of the T-tail stabilizer systems 402, 403 are horizontal stabilizers. The horizontal stabilizers, including the port horizontal stabilizer 406 and the starboard horizontal stabilizer 408, have separate control surfaces that preferably include individual elevators and may include aileron panels for those embodiments where the elevators are not preferred for small amounts of aileron deflection.

An alternative embodiment of the aircraft configuration as illustrated by example in FIG. 4B, has a T-tail stabilizer system that is a full T-tail stabilizer system 404 including a horizontal stabilizer 410 in the form of a single, continuous control surface that spans from the port vertical stabilizer 124 to the starboard vertical stabilizer 120.

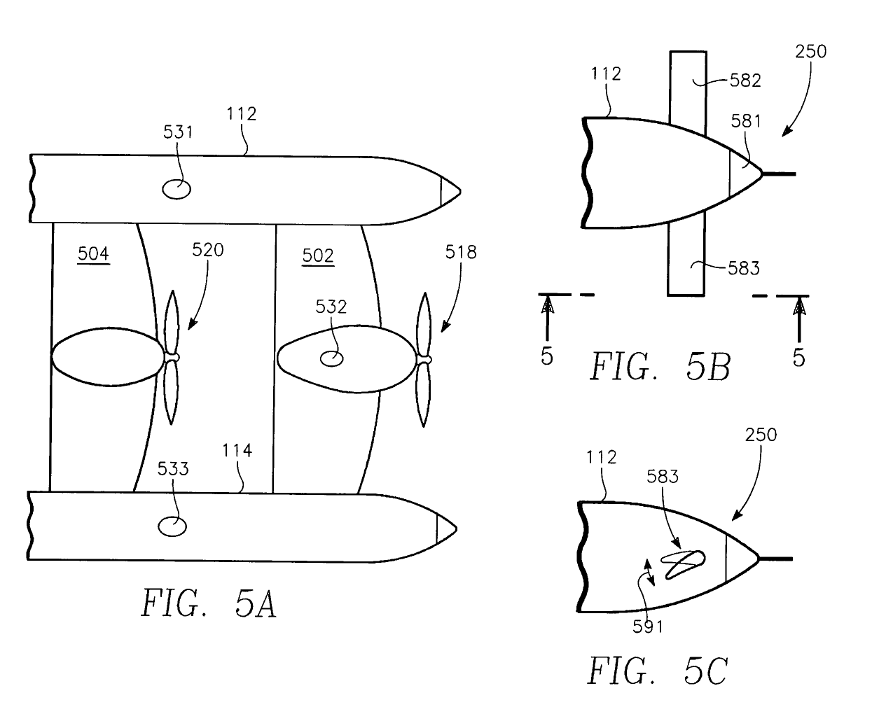

FIG. 5A illustrates a forward portion of the planform view of an exemplary embodiment of the present invention where propulsion systems are mounted to one or more of the wings.

In this illustration, a forward propulsion system 518 is mounted on a forward wing 502 and an aft propulsion system is mounted on an aft wing 504. In some embodiments, a cockpit 531 for manned flight or for autopilot electronics is integrated into the upper portion of the port fuselage 112, midway between the forward wing 102 and aft wing 104.

Likewise, in some embodiments, a cockpit 533 for manned flight or for autopilot electronics is integrated into the upper portion of the starboard fuselage 114, midway between the forward wing 102 and aft wing 104. In some embodiments, a cockpit 532 may be centrally located in the forward wing 102.

FIG. 5B is a top planform view of a forward section of a port fuselage 112 of an exemplary embodiment providing further detail of an exemplary port canard-nosecone assembly 250. The exemplary canard-nosecone assembly 250 includes a nosecone 581, an outboard surface 582 and an inboard surface 583. In this embodiment, a symmetric starboard canard-nosecone assembly 252 is preferably integrated with the starboard fuselage 114.

FIG. 5C illustrates another embodiment of the present invention having for example a port canard system 250 as viewed from the side, and indicated by view 5 of FIG. 5B, where the canard surfaces are actuated and thereby act as part of the overall vehicle control system. The direction of motion is indicated by the bidirectional arrow 591. The outboard port canard 582 may also have an aileron flap 261 (see FIG. 2). The aileron flap 261 may be used to control and induce rolling motion for the aircraft.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

We claim:

1. An aircraft comprising:
a port fuselage comprising:
a substantially cylindrical body having a port centerline, a nose portion, a mid-body portion and a tail portion;
a port vertical stabilizer mounted topside and proximate to the tail portion of the port fuselage;
an outboard port canard, proximate to the nose portion of the port fuselage, and
a port propulsion unit mounted along the port centerline;
a starboard fuselage substantially parallel to and coplanar with the port fuselage, the starboard fuselage comprising:
a substantially cylindrical body having a starboard centerline, a nose portion, a mid-body portion and a tail portion;
a starboard vertical stabilizer mounted topside and proximate to the tail portion of the starboard fuselage;
an outboard starboard canard, proximate to the nose portion of the starboard fuselage; and
a starboard propulsion unit mounted along the starboard centerline;
a forward wing having a leading edge and a trailing edge, the forward wing interposed between the mid-body portion of the port fuselage and the mid-body portion of the starboard fuselage;
an aft wing having a leading edge and a trailing edge, the aft wing interposed between the mid-body portion of the port fuselage and the mid-body portion of the starboard fuselage and substantially parallel to and above the plane of the forward wing wherein the leading edge of the aft wing is aft of the trailing edge of the forward wing; and
a horizontal stabilizer spanning from an upper section of the port vertical stabilizer and an upper section of the starboard vertical stabilizer.

2. The aircraft as claimed in claim 1 further comprising a forward wing propulsion unit mounted at substantially mid-span of the forward wing and proximate to the leading edge of the forward wing and an aft wing propulsion unit mounted at substantially mid-span of the forward wing and proximate to the leading edge of the aft wing.

3. The aircraft as claimed in claim 1 wherein the forward wing is adapted to pivot substantially about the leading edge of the forward wing wherein the trailing edge subtends an angle of less than twenty-one degrees.

4. The aircraft as claimed in claim 1 wherein the outboard port canard has a deflectable aileron panel and the outboard starboard canard has a deflectable aileron panel.

5. The aircraft as claimed in claim 1 wherein the port propulsion unit is a turbo-prop system mounted at the nose portion of the port fuselage and the starboard propulsion unit is a turbo-prop system mounted at the nose portion of the starboard fuselage.

6. The aircraft as claimed in claim 1 wherein the port propulsion unit is a pusher turbo-prop system mounted at the tail portion of the port fuselage and the starboard propulsion unit is a pusher turbo-prop system mounted at the tail portion of the starboard fuselage.

7. The aircraft as claimed in claim 1 wherein the port fuselage further comprises in inboard canard proximate to the nose portion of the port fuselage and wherein the starboard fuselage further comprises in inboard canard proximate to the nose portion of the starboard fuselage.

8. An aircraft comprising:
a port fuselage comprising:
a substantially cylindrical body having a port centerline, a nose portion, a mid-body portion and a tail portion;
a port T-tail stabilizer system mounted topside and proximate to the tail portion of the port fuselage;
an outboard port canard, proximate to the nose portion of the port fuselage, and
a port propulsion unit mounted along the port centerline;
a starboard fuselage substantially parallel to and coplanar with the port fuselage, the starboard fuselage comprising:
a substantially cylindrical body having a starboard centerline, a nose portion, a mid-body portion and a tail portion;
a starboard T-tail stabilizer system mounted topside and proximate to the tail portion of the starboard fuselage;
an outboard starboard canard, proximate to the nose portion of the starboard fuselage; and
a starboard propulsion unit mounted along the starboard centerline;
a forward wing having a leading edge and a trailing edge, the forward wing interposed between the mid-body portion of the port fuselage and the mid-body portion of the starboard fuselage;
an aft wing having a leading edge and a trailing edge, the aft wing interposed between the mid-body portion of the port fuselage and the mid-body portion of the starboard fuselage and substantially parallel to and above the plane of the forward wing wherein the leading edge of the aft wing is aft of the trailing edge of the forward wing; and
a horizontal stabilizer spanning from an upper section of the port vertical stabilizer and an upper section of the starboard vertical stabilizer.

9. The aircraft as claimed in claim 8 further comprising a forward wing propulsion unit mounted at substantially mid-span of the forward wing and proximate to the leading edge of the forward wing and an aft wing propulsion unit mounted at substantially mid-span of the forward wing and proximate to the leading edge of the aft wing.

10. The aircraft as claimed in claim 8 wherein the forward wing is adapted to pivot substantially about the leading edge of the forward wing wherein the trailing edge subtends an angle of less than twenty-one degrees.

11. The aircraft as claimed in claim 8 wherein the outboard port canard has a deflectable aileron panel and the outboard starboard canard has a deflectable aileron panel.

12. The aircraft as claimed in claim 8 wherein the port propulsion unit is a turbo-prop system mounted at the nose portion of the port fuselage and the starboard propulsion unit is a turbo-prop system mounted at the nose portion of the starboard fuselage.

13. The aircraft as claimed in claim 8 wherein the port propulsion unit is a pusher turbo-prop system mounted at the tail portion of the port fuselage and the starboard propulsion unit is a pusher turbo-prop system mounted at the tail portion of the starboard fuselage.

14. The aircraft as claimed in claim 8 wherein the port fuselage further comprises in inboard canard proximate to the nose portion of the port fuselage and wherein the starboard fuselage further comprises in inboard canard proximate to the nose portion of the starboard fuselage.

15. An aircraft comprising:
a port fuselage comprising:
a substantially cylindrical body having a nose portion, a mid-body portion and a tail portion;
a port vertical stabilizer mounted topside and proximate to the tail portion of the port fuselage; and
a port propulsion unit mounted proximate to the tail portion of the port fuselage;
a starboard fuselage substantially parallel to and coplanar with the port fuselage, the starboard fuselage comprising:
a substantially cylindrical body having a nose portion, a mid-body portion and a tail portion;
a starboard vertical stabilizer mounted topside and proximate to the tail portion of the starboard fuselage;
an outboard starboard canard, proximate to the nose portion of the starboard fuselage; and
a starboard propulsion unit mounted proximate to the tail portion of the starboard fuselage;
a forward wing having a leading edge and a trailing edge, the forward wing interposed between the mid-body portion of the port fuselage and the mid-body portion of the starboard fuselage;
an aft wing having a leading edge and a trailing edge, the aft wing interposed between the mid-body portion of the port fuselage and the mid-body portion of the starboard fuselage and substantially parallel to and above the plane of the forward wing wherein the leading edge of the aft wing is aft of the trailing edge of the forward wing; and
a horizontal stabilizer spanning from an upper section of the port vertical stabilizer and an upper section of the starboard vertical stabilizer.

16. The aircraft as claimed in claim 15 further comprising a forward wing propulsion unit mounted at substantially mid-span of the forward wing and proximate to the leading edge of the forward wing and an aft wing propulsion unit mounted at substantially mid-span of the forward wing and proximate to the leading edge of the aft wing.

17. The aircraft as claimed in claim 15 wherein the forward wing is adapted to pivot substantially about the leading edge of the forward wing wherein the trailing edge subtends an angle of less than twenty-one degrees.

18. The aircraft as claimed in claim 15 wherein the port fuselage further comprises an outboard port canard extending from the nose portion of the port fuselage and the starboard fuselage further comprises an outboard starboard canard extending from the nose portion of the starboard fuselage wherein the outboard port canard has a deflectable aileron panel and the outboard starboard canard has a deflectable aileron panel.

19. The aircraft as claimed in claim 18 wherein the port fuselage further comprises in inboard canard proximate to the nose portion of the port fuselage and wherein the starboard fuselage further comprises in inboard canard proximate to the nose portion of the starboard fuselage.

20. The aircraft as claimed in claim 15 wherein the port propulsion unit is a pusher turbo-prop system and the starboard propulsion unit is a pusher turbo-prop system.
